(19) United States
(12) Patent Application Publication
(10) Pub. No.: US 2019/0041582 A1
(43) Pub. Date: Feb. 7, 2019

(54) POLYMER OPTICAL COUPLER

(71) Applicant: Intel Corporation, Santa Clara, CA (US)

(72) Inventors: John Heck, Berkeley, CA (US); Hari Mahalingam, Fremont, CA (US)

(73) Assignee: Intel Corporation, Santa Clara, CA (US)

(21) Appl. No.: 15/980,103

(22) Filed: May 15, 2018

(51) Int. Cl. G02B 6/30

(52) U.S. Cl. CPC G02B 6/305; G02B 6/30

(57) ABSTRACT

Embodiments may relate to a polymer optical coupler. The polymer optical coupler may include a first portion at least partially coupled to a face of a silicon waveguide. The polymer optical coupler may further include a second portion of the polymer optical coupler that is adjacent to the first portion and which may have a width that is less than a width of the second portion opposite the first portion. Other embodiments may be described and/or claimed.

### FIELD

Embodiments of the present disclosure generally relate to the field of optical couplers, and more particularly, to optical couplers that can couple a photonic chip and an optical fiber.

### BACKGROUND

In silicon photonic devices such as a photonic chip, light in silicon waveguides may support optical modes with a relatively small profile, for example on the order of approximately 0.2 to 1 micrometer (um or micron). By contrast, single mode fibers (SMF) may typically support an optical mode size on the order of approximately 10 microns. In some legacy devices, the optical mode may be expanded from a submicron silicon waveguide to a silicon nitride waveguide, thereby expanding the optical mode size to the order of approximately 5 microns. However, it may be difficult to realize a silicon nitride waveguide coupler that can expand the mode to approximately 10 microns. Rather, legacy solutions may use a lens to collect light diverging from the waveguide (either the silicon waveguide or a silicon nitride waveguide, for example) and image it onto the fiber facet. This legacy solution may be undesirable in some cases because it may require additional alignment and bonding steps which may provide negative limits to the manufacturability and cost of the solution.

### BRIEF DESCRIPTION OF THE DRAWINGS

FIG. 1 illustrates an example system that may use an optical coupler, in accordance with various embodiments.

FIG. 2 illustrates a simplified cut-away side view of an embodiment of an optical coupler, in accordance with various embodiments.

FIG. 3 illustrates a simplified top-down view of the embodiment of the optical coupler of FIG. 2, in accordance with various embodiments.

FIG. 4 illustrates a simplified perspective view of the embodiment of the optical coupler of FIG. 2, in accordance with various embodiments.

FIG. 5 illustrates a simplified cut-away side view of an alternative embodiment of an optical coupler, in accordance with various embodiments.

FIG. 6 illustrates a simplified top-down view of the embodiment of the optical coupler of FIG. 5, in accordance with various embodiments.

FIG. 7 illustrates a simplified perspective view of the embodiment of the optical coupler of FIG. 5, in accordance with various embodiments.

FIG. 8 illustrates a simplified cut-away view of an alternative embodiment of an optical coupler, in accordance with various embodiments.

FIG. 9 illustrates a simplified top-down view of the embodiment of the optical coupler of FIG. 8, in accordance with various embodiments.

FIG. 10 illustrates an example process flow for constructing an optical coupler, in accordance with various embodiments.

### DETAILED DESCRIPTION

Embodiments may relate to a polymer optical coupler. The polymer optical coupler may include a first portion at least partially coupled to a face of a silicon waveguide and a second portion coupled to a face of a dielectric stack. The second portion of the polymer optical coupler that is adjacent to the first portion may have a width that is less than a width of the second portion opposite the first portion. Other embodiments may be described and/or claimed.

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A or B” means (A), (B), or (A and B). For the purposes of the present disclosure, the phrase “A, B, or C” means (A), (B), (C), (A and B), (A and C), (B and C), or (A, B and C).

The description may use perspective-based descriptions such as top/bottom, in/out, over/under, and the like. Such descriptions are merely used to facilitate the discussion and are not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or elements are in direct contact.

In various embodiments, the phrase “a first feature formed, deposited, or otherwise disposed on a second feature,” may mean that the first feature is formed, deposited, or disposed over the feature layer, and at least a part of the first feature may be in direct contact (e.g., direct physical and/or electrical contact) or indirect contact (e.g., having one or more other features between the first feature and the second feature) with at least a part of the second feature.

Various operations may be described as multiple discrete operations in turn, in a manner that is most helpful in understanding the claimed subject matter. However, the order of description should not be construed as to imply that these operations are necessarily order dependent.

As used herein, the term “module” may refer to, be part of, or include an application specific integrated circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

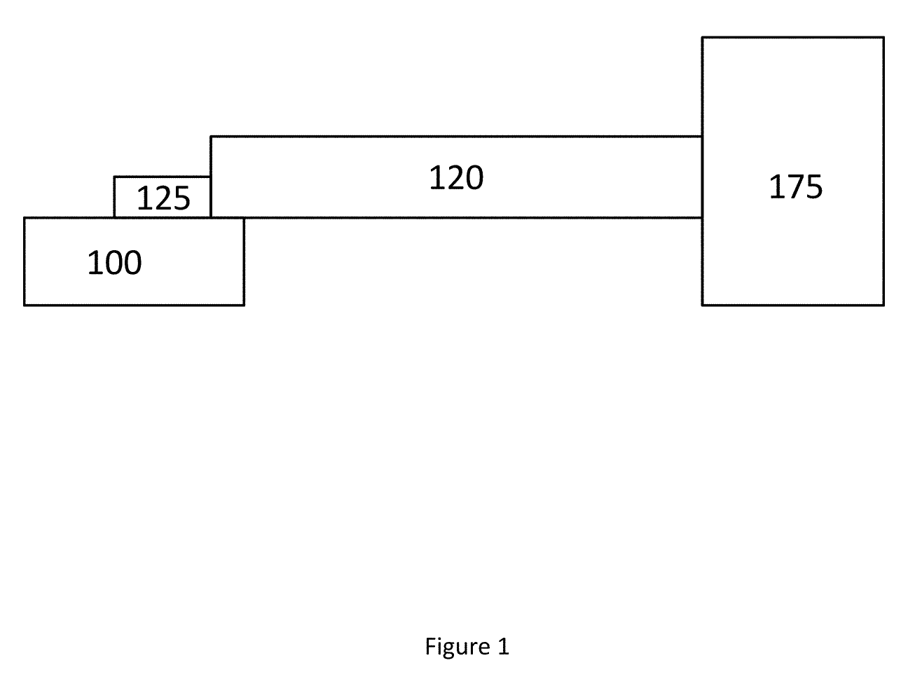

FIG. 1 illustrates an example system that may use an optical coupler, in accordance with various embodiments. Specifically, FIG. 1 depicts a system that may include a photonic chip 100 and an optical fiber 120. The photonic chip 100 may be, for example, a chip such as a processor, a central processing unit (CPU), a graphics processing unit (GPU), a memory, or some other type of chip. More specifically, the photonic chip 100 may be a chip that at least partially uses light rather than electrical signals to communicate information within the photonic chip 100 or externally from the photonic chip 100.

In some embodiments the photonic chip 100 may be coupled with an optical fiber 120. More specifically, the optical fiber 120 may be a SMF. As used herein, a SMF may refer to an optical fiber that is designed to carry light in only a single mode. In embodiments, the optical fiber 120 may include silicon or some other optically conductive material, and may include various elements such as a core, a cladding, a buffer, or a jacket. For example, the SMF may be designed to only carry light directly down the fiber, a mode which may be referred to as a transverse mode. For example, in some embodiments the optical fiber 120 may be configured to carry optical signals from the photonic chip 100 to another component 175. The component 175 may be, for example, another photonic chip, a memory, a processor, or some other type of component that may either be coupled directly to the optical fiber 120 or may be coupled to the optical fiber 120 via some other type of coupling.

As noted above, the photonic chip 100 may be implemented with a silicon waveguide that may support optical modes with a submicron profile, for example on the order of between approximately 0.2 microns and 1 micron. Specifically, the silicon waveguide may be a waveguide that directs light in a specific direction due to internal refraction of the waveguide. The silicon waveguide may be made out of pure or lightly doped silicon. More specifically, the silicon waveguide may be doped with boron, phosphorus, or some other doping agent.

By contrast, the optical fiber 120 may support optical modes with a profile on the order of approximately 10 microns. As used herein, the profile of the optical mode may refer to the diameter of the region through which the light propagates. In order to expand the profile of the light from the submicron profile of the photonic chip 100 to the profile of the optical fiber 120, the photonic chip 100 may include or be coupled with an optical coupler 125 that is designed to expand the profile of the light.

Additionally, as noted above, legacy solutions may have included a silicon nitride waveguide coupled to the silicon waveguide of the photonic chip 100. The silicon nitride waveguide may expand the submicron profile to a profile on the order of approximately 5 microns, and then a lens may be used to collect the light diverging from the waveguide(s) and image that light onto a fiber facet. However, as noted, this legacy solution may be undesirable in some cases because it may require additional alignment and bonding steps which may provide negative limits to the manufacturability and cost of the solution.

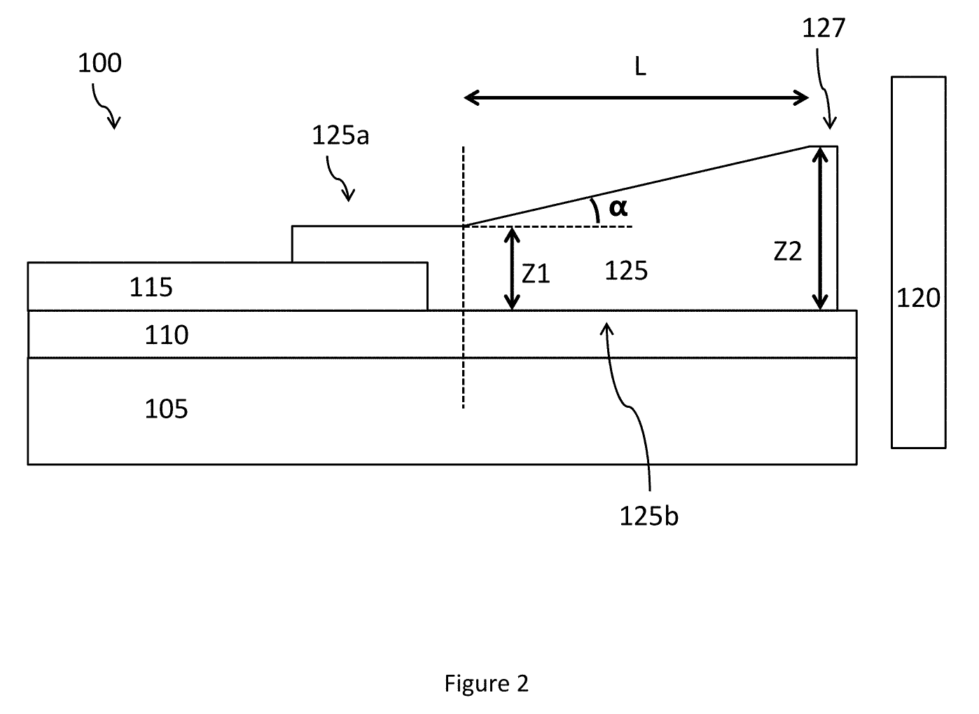

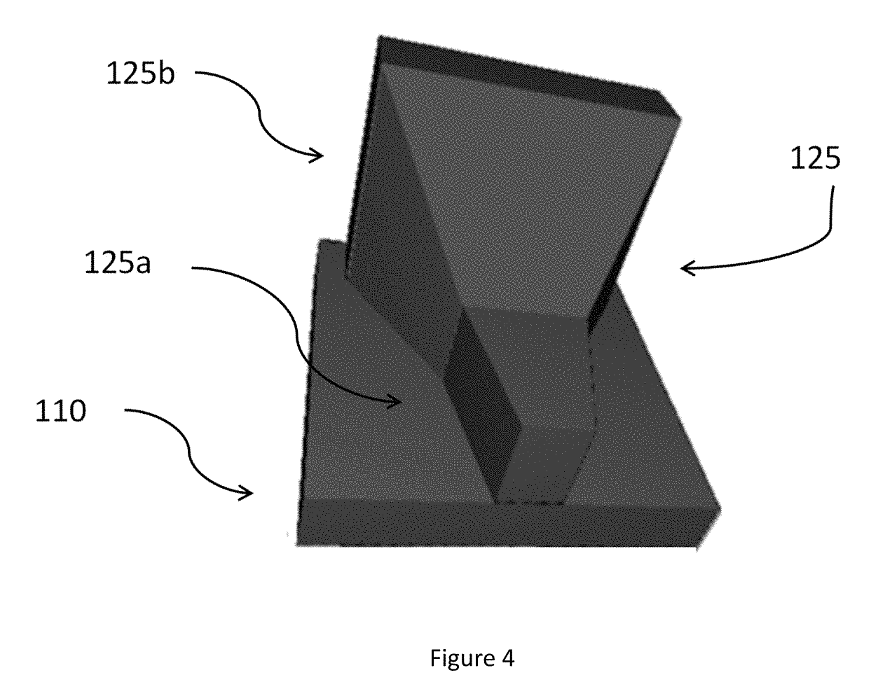

FIGS. 2, 3, and 4 depict various views an example embodiment of a photonic chip 100 with an optical coupler 125. Generally, the photonic chip 100 may include a variety of layers such as a silicon wafer 105, a dielectric stack 110, and a silicon waveguide 115. More specifically, the photonic chip 100 may be a silicon-on-insulator (SOI) wafer, where the dielectric stack 110 is a silicon dioxide layer and the silicon waveguide 115 is monocrystalline silicon. The silicon wafer 105 may be composed of, for example silicon, and have a thickness (or z-height) of approximately 0.75 millimeters (mm). The dielectric stack 110 may be composed of, for example, silicon dioxide and may have a thickness (or z-height) of between approximately 0.5 and approximately 3 microns.

As described above, the silicon waveguide 115 may support optical modes with a submicron profile, for example on the order of between approximately 0.2 microns and 1 micron. Specifically, the silicon waveguide may be a waveguide that directs light in a specific direction due to internal refraction of the waveguide. Specifically, with respect to FIG. 2, the silicon waveguide 115 may direct light from the left side of the page to the right side of the page. The silicon waveguide may be made out of pure or lightly doped silicon as described above. The silicon waveguide 115 may have a z-height of approximately 1 micron and a width of approximately 1 micron. The length of the silicon waveguide 115 may be dependent on the size of the photonic chip 100, the use to which the photonic chip 100 will be put to, or some other design guideline.

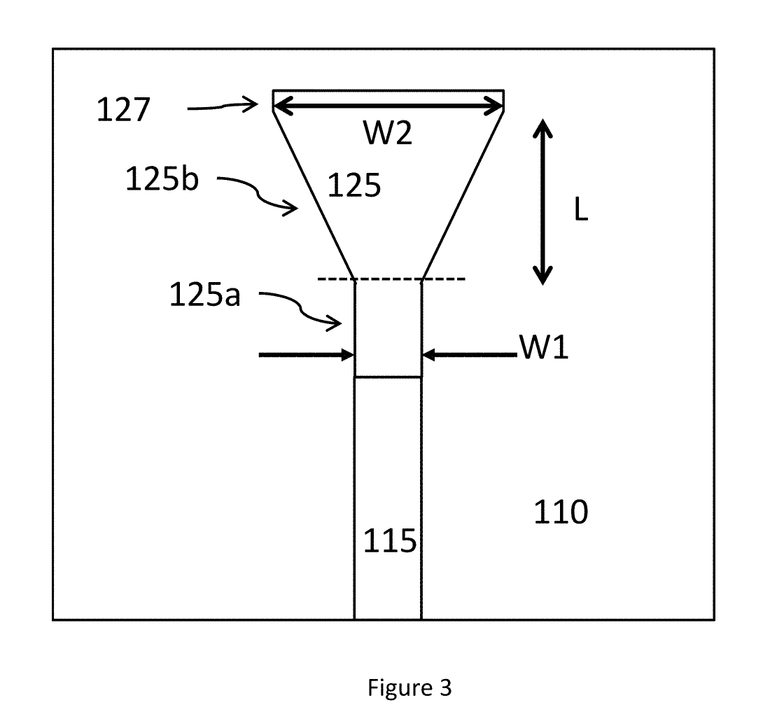

As used herein, the term “height” or “z-height” may be used interchangeably herein and may refer to the vertical height as depicted in FIG. 2. For example, the z-height of the silicon waveguide 115 may refer to the distance that the silicon waveguide extends from the surface of the dielectric stack 110. Various heights are depicted in FIG. 2 as “Z1” and “Z2” and will be addressed further herein. The term “z-height” may further refer to the distance that an element extends from the face of the page in FIG. 3.

Similarly, the term “length” may be used to refer to a measurement perpendicular to the “height” and may refer to, for example, the distance from the left side of FIG. 2 to the right side of FIG. 2 (or vice versa). A length of an element is depicted in FIG. 2 as “L” and will be discussed further herein. The term “length” may also refer to a distance from the top of FIG. 3 to the bottom of FIG. 3 (or vice versa).

Similarly, the term “width” may be used to refer to a measurement perpendicular to the height and length and may refer to, for example, a distance out of the page in FIG. 2, or from the left side of FIG. 3 to the right side of FIG. 3.

In embodiments, the optical coupler 125 may also be positioned on the dielectric stack 110. The optical coupler 125 may include two portions 125a and 125b. In some embodiments the different portions may be referred to as different “stages” of the optical coupler 125. In FIG. 2, the different portions are indicated by the vertical dashed line. Similarly, in FIG. 3, the two portions are indicated by the horizontal dashed line. Generally, the optical coupler 125 may be formed of a polymer such as an ultraviolet (UV)-curable acrylate material or some other polymer. More generally, the optical coupler 125 may be formed of a polymer that has a refractive index up to approximately 1.56. In embodiments, the optical coupler 125 may be stamped directly onto the silicon waveguide 115, the dielectric stack 110, or some other portion of the photonic chip 100 as will be described herein. In other embodiments, the optical coupler 125 may be formed through some other technique or process.

The first portion, 125a, may have a generally uniform height and width as shown in FIGS. 2-4. For example, the first portion 125a may have a height and a width of approximately 4 microns. As can be seen in FIG. 2, the first portion 125a may at least partially overlap the silicon waveguide 115. This overlap may allow light to expand from the silicon waveguide 115 into the first portion 125a, thereby increasing the profile of the light from a profile on the order of 0.2-1 micron to a profile of approximately 4 microns.

The second portion 125b may then increase from the first height Z1 and width W1 to a second height Z2 and a second width W2. In some embodiments the first height Z1 and the first width W1 may be the same or approximately the same as the height and width of the first portion 125a, that is approximately 4 microns by 4 microns. The second height Z2 and the second width W2 may be larger than the height and the width of the first portion 125a, as shown in FIGS. 2-4. More specifically, the height Z2 and width W2 may be between approximately 8 microns and approximately 20 microns. This increase may occur over the length L of the second portion 125b. In some embodiments, the length L may be between approximately 200 and approximately 1000 microns. Generally, the increase may occur relatively uniformly over the length L of the second portion 125b, and for example the angle a of the height increase may be approximately 1 degree.

As can be seen in FIGS. 2-4, in some embodiments there may be a facet 127 at the end of the optical coupler 125. The facet 127 may be coated by an anti-reflective coating that may prevent reflections from the optical fiber 120 back into the photonic chip 100. Once light leaves the facet 127, it may be directly butt-coupled into the optical fiber 120, or alternately collected by a lens (not shown) into a section of free-space optical that may couple it into the optical fiber 127.

In some embodiments, the facet 127 may not be flush with the end of the dielectric stack 110. For example, as can be seen in FIG. 3, the facet 127 may not be flush with the end of the dielectric stack 110. The facet 127 may be set back from the edge of the dielectric stack 110 because the die may need to be singulated in such a way as to not damage the facet due to the singulation process. The singulation process may be done using a dicing saw, a scribe-and-break process, or a laser-based “stealth dicing” process. Alternatively, the facet 127 may overhang the end of layers 110 and 105.

In operation, the photonic chip 100, and particularly the optical coupler 125, may allow light to expand adiabatically from the 0.2 microns and 1 micron profile of the silicon waveguide 115 to an approximately 8-20 micron profile through the optical coupler 125. As used herein, the term “adiabatic” refers to expansion of the light without un-necessary loss outside of the silicon waveguide 115 and the optical coupler 125. For example, in the first portion 125a, the light may expand from the 0.2-1 micron profile of the silicon waveguide 115 to an approximately 4×4 micron profile of the first portion 125a of the optical coupler 125. The light may then expand from the approximately 4×4 micron profile through the second portion 125b of the optical coupler 125 to the approximately 8-20 micron profile at the facet 127.

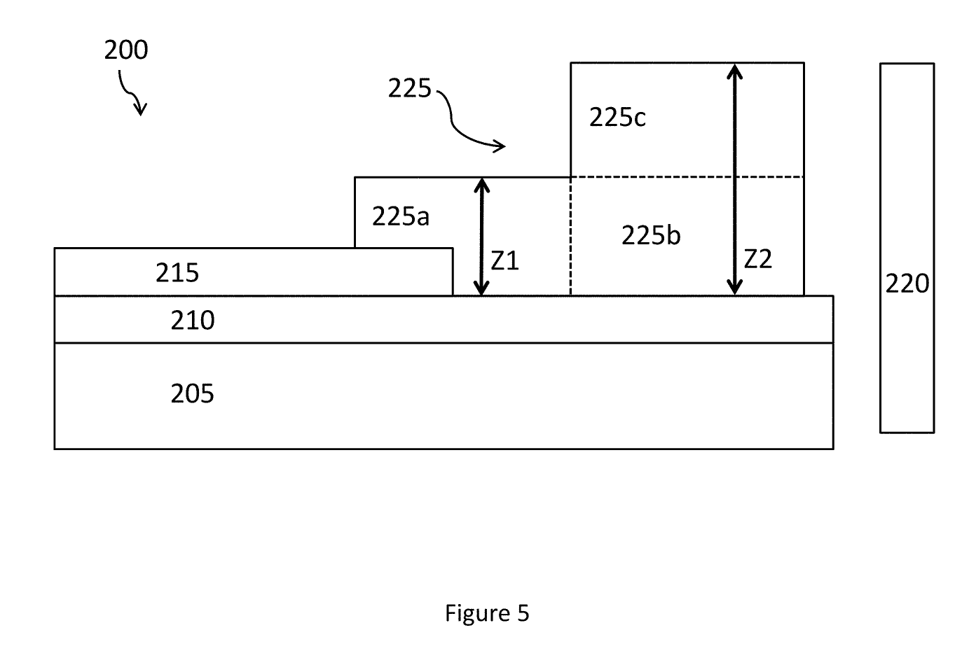

FIGS. 5-7 depict an alternative embodiment of a photonic chip 200 with an optical coupler 225. The photonic chip 200 may include a silicon wafer 205, a dielectric stack 210, and a silicon waveguide 215, which may be respectively similar to silicon wafer 105, dielectric stack 110, and silicon waveguide 115. In embodiments, the photonic chip 200 may be couplable to an optical fiber 220, which may be similar to optical fiber 120.

The photonic chip 200 may also include or be coupled with an optical coupler 225, which may in some respects be similar to optical coupler 125. For example, the optical coupler 225 may be formed of a polymer material similar to that described above with respect to optical coupler 125. Additionally, the optical coupler 225 may be formed by a stamping process as described herein, or through some other process. Similarly to optical coupler 125, optical coupler 225 may include a facet 227 at an end of the optical coupler 225 further from the waveguide 115.

As shown in FIGS. 5-7, the optical coupler 225 may include a first portion 225a which may be similar to first portion 125a of optical coupler 125. Specifically, the first portion 225a may have a first height Z1 and a first width W1, both of which may, in some embodiments, be equal to approximately 4 microns.

The optical coupler 225 may also have a second portion 225b. As shown, for example in FIG. 5, the second portion 225b may have a relatively constant height Z1, which may be approximately the same as the height of the first portion 225a. In some embodiments, the second portion 225b may have a different height than the first portion 225a, for example the second portion 225b may be slightly “taller” or “shorter” than the first portion 225a. Additionally, in some embodiments the second portion 225b may be sloped so that it rises or falls with respect to the height Z1. That is, the height of the second portion 225b at a side of the second portion 225b furthest from the first portion 225a may be higher or lower than height Z1.

The second portion 225b may also expand from the first width W1 at the side closest to the first portion 225a, to a second width W2 at a side furthest from the first portion 225a. In some embodiments, the second width W2 may be on the order of approximately 8 to approximately 20 microns wide. The second portion 225b may expand relatively evenly over a length L that is between approximately 200 and approximately 400 microns.

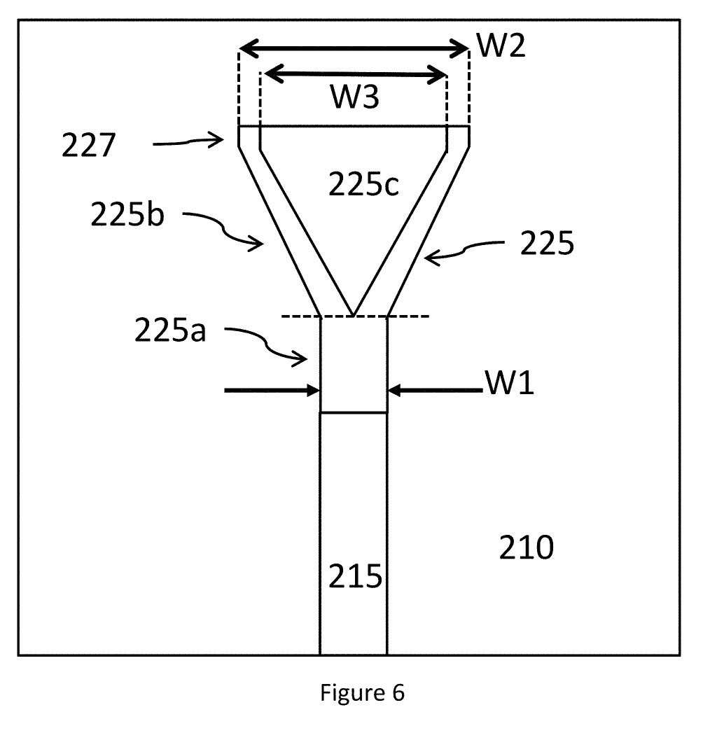

The optical coupler 225 may also include a third portion 225c that may be disposed over the second portion 225b. As can be seen in FIG. 6, the third portion 225c may be generally triangular, though in other embodiments the third portion 225c may have some other cross sectional shape such as trapezoidal, an arc, a square, or some other shape. In embodiments, the third portion 225c may have a general even height from the side closest to the first portion 225a to the side furthest from the first portion 225a. In other embodiments, the third portion 225c may slope such that the height of the third portion closest to the first portion 225a may be higher or lower than the height of the third portion 225c furthest from the first portion 225a. In some embodiments, the combined height of the second portion 225b and the third portion 225c at the side further from the first portion 225a may be a height Z2, as shown in FIG. 5. In embodiments, the height Z2 may be between 8 and 20 microns, similarly to the height Z2 depicted in FIG. 2.

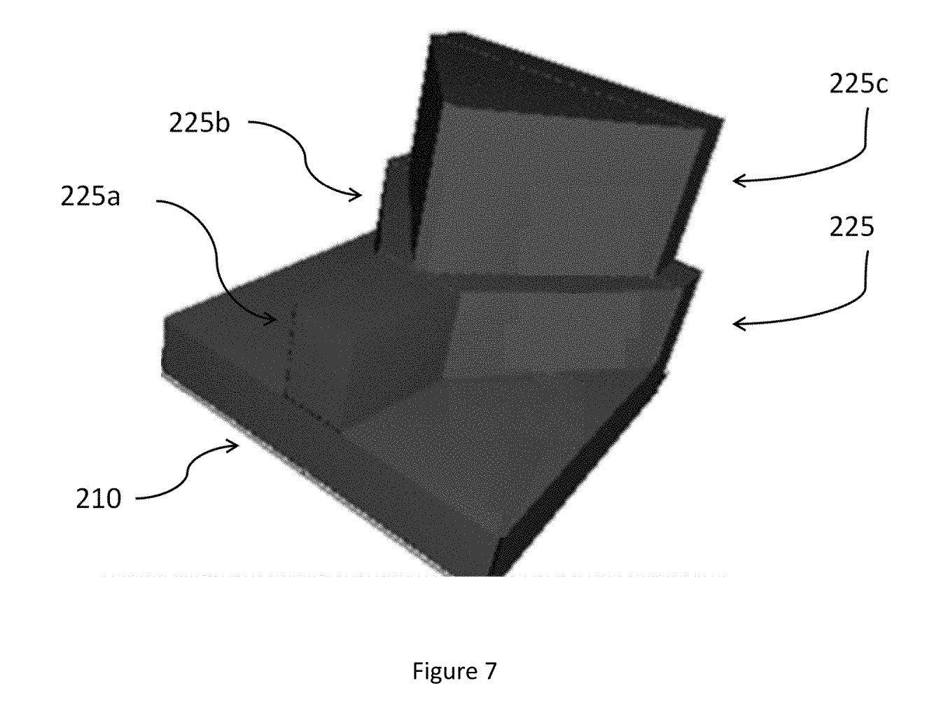

Additionally, as can be seen in FIGS. 6 and 7, the third portion 225c may have a smaller width than the second portion 225b. Specifically, at the end of the third portion 225c closest to the first portion 225a, it can be seen in FIG. 6 that the third portion 225c may be relatively narrow. Specifically, it is depicted as being “pointed” or generally “arrowhead” shaped, however, in other embodiments it may be rounded, squared off, or some other shape. At the end of the third portion 225c furthest from the first portion 225a, the third portion 225c may have a width W3 that is less than the width W2 of the second portion 225b. In some embodiments, the width W3 may be between approximately 4 and approximately 18 microns wise. The reason that the third portion 225c may have a smaller width at a given point than the second portion 225b may be so that the light is able to gradually, and therefore adiabatically, expand from the first portion 225a into the second portion 225b, and then from the second portion 225b into the third portion 225c. In this way, the light may be able to expand throughout the optical coupler 225, thereby increasing its profile from the approximately 0.2-1 micron profile of the silicon waveguide 215 to the desired approximately 8-20 micron profile of the optical coupler 225.

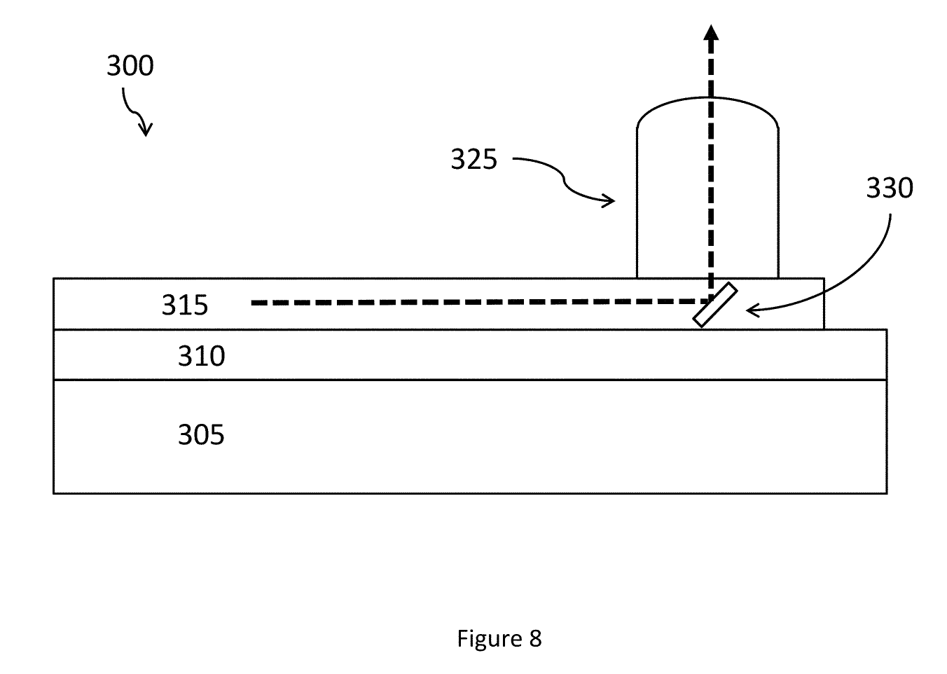

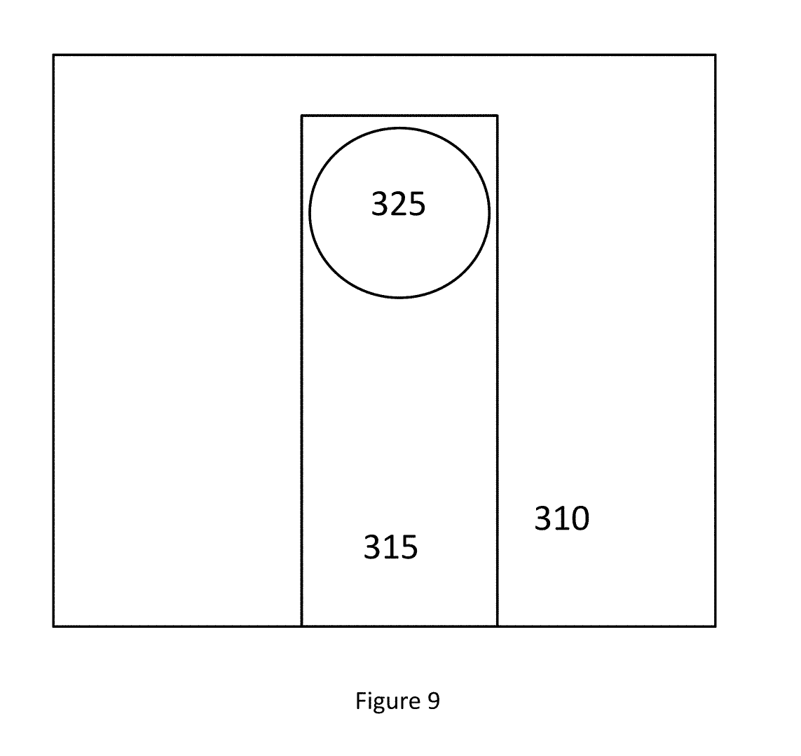

FIGS. 8 and 9 depict an alternative embodiment of a photonic chip 300 that may use an optical coupler 325. In embodiments, the photonic chip 300 may include a silicon wafer 305 and a dielectric stack 310, which may be respectively similar to silicon wafer 105 and dielectric stack 110.

The photonic chip 300 may also include a silicon waveguide 315, which may be similar to silicon waveguides 115 or 215. Specifically, the silicon waveguide may be composed of pure or lightly doped silicon as described above. In some embodiments, the silicon waveguide 315 may include a mirror 330 wholly or partially embedded therein. The dotted line in FIG. 8 represents the path of light throughout the photonic chip 300. As can be seen, the light may traverse the silicon waveguide 315 until it strikes the mirror 330, at which point the mirror 330 may change the path of the light.

As shown in FIG. 8, the photonic chip 300 may include an optical coupler 325. The optical coupler 325 may have been wholly or partially stamped directly onto the silicon waveguide 315 or the dielectric stack 310. In other embodiments, the optical coupler 325 may be formed through some other technique or process. In embodiments, the optical coupler 325 may be formed of a polymer material such as the polymer materials described above with respect to optical couplers 125 or 225. As can be seen, the optical coupler 325 may generally rise above the silicon waveguide 315 and may be domed. Specifically, in some embodiments the optical coupler 325 may have a width and a length of between approximately 100 microns and approximately 1 mm and a height of between approximately 100 microns and approximately 1 mm. In some embodiments the optical coupler 325 may be “domed” such that it forms a natural lens, while in other embodiments the optical coupler 325 may have one or more depressions, be flat, have a plurality of domes, or be some other shape. In some embodiments the optical coupler 325 may have a generally circular top-down profile, for example as shown in FIG. 9, while in other embodiments the optical coupler 325 may have a different top-down profile such as oblong, rectangular, square, triangular, non-uniform, etc.

It will be understood that the above values, for example with respect to measurements of specific elements or sizes, are intended herein only as examples for the sake of description. Other embodiments may have different sizes, profiles, heights, widths, lengths, or angles. Additionally, illustrations of specific sizes or dimensions in FIGS. 2-8 are intended only for the sake of description and are not intended to illustrates real world comparative sizes or ratios. Additionally, it will be understood that other embodiments may have additional or alternative layer counts. For example, in some embodiments the optical couplers 125 and 225 may be said to be two-layer optical couplers, that is having two layers each. However, in other embodiments the optical couplers may have an increased number of layers to allow for further propagation of light through the optical couplers.

Generally, an optical coupler such as optical couplers 125, 225, or 325 may be composed of a stamped polymer such as the polymers described above. Formation of the optical coupler 125/225/325 may include generating a three-dimensional “master.” The master may be formed by diamond turning or some other process. The master may then be used to make stamps to form polymer features on a wafer. In some embodiments, the polymer features may be formed through a stamp-and-repeat process, or in a full-wafer process. As used herein, a stamp-and-repeat process may mean that one or more couplers are formed in a limited area on the wafer by a master stamp in one step, and this operation is repeated across the wafer until all required couplers are completed, and a full-wafer process may mean that all the couplers needed on the entire wafer are formed by a large master stamp in a single step. In embodiments the stamp-and-repeat process may have a placement accuracy in the submicron range, while the full-wafer process may have a placement accuracy in the range of a few microns.

In embodiments, the polymer may be dispensed using inkjet technology with a precise volume, either on the stamp or directly onto the dielectric stack 110/210/320 or the silicon waveguide 115/215/315. The polymer may then be cured, for example via UV light, through the stamp. The stamp is then removed, leaving the optical coupler 125/225/325 as a high-quality reproduction of the master structure.

It will be understood that the above description of how the optical coupler 125/225/325 may be formed is merely one example, and other embodiments may be formed via different means. For example, in other embodiments the polymer may be dispensed using a different technology, or it may be cured in some other manner. Generally, in embodiments the polymer may be deposited directly on the dielectric stack 110/210/310 and the silicon waveguide 115/215/315.

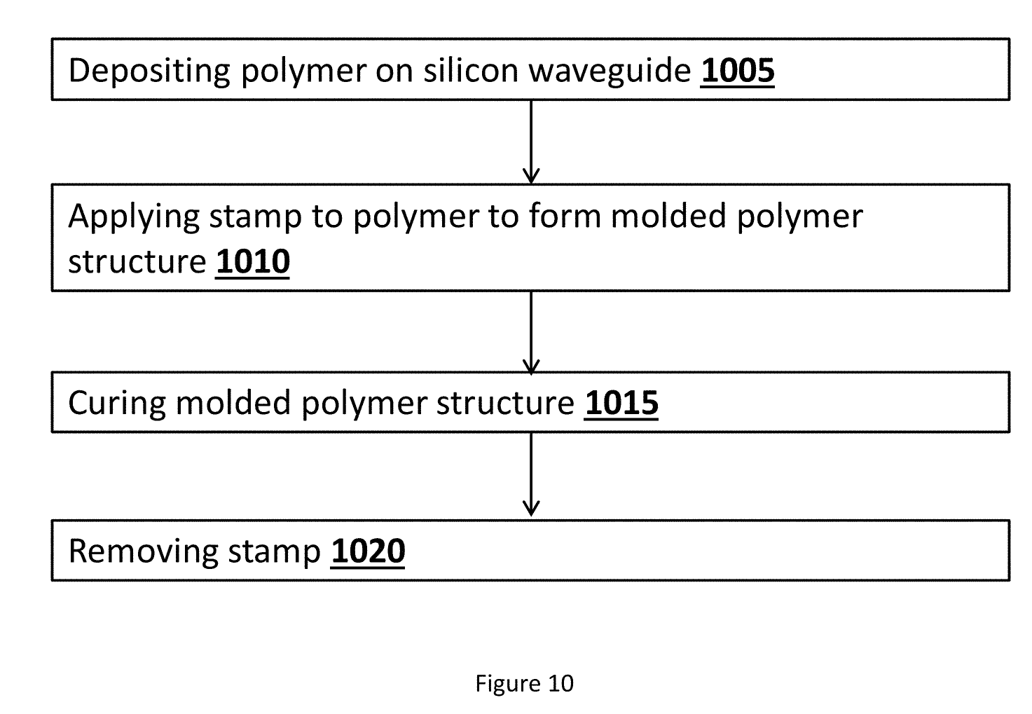

FIG. 10 depicts an example process that may be used to form an optical coupler such as optical couplers 125, 225, or 325. In embodiments, the process may include depositing a polymer on a silicon waveguide at 1005. The polymer may be, for example, a polymer such as the polymers described above. The silicon waveguide may be, for example, a silicon waveguide such as silicon waveguides 115/215/315. In some embodiments, the polymer may also at least partially be deposited onto the dielectric stack on which the silicon waveguides are positioned, for example dielectric stacks 110/210/310. In some embodiments, the polymer may be fully deposited onto the dielectric stack rather than the silicon waveguide. As described above, in some embodiments the polymer may be deposited via inkjet printing, whereas in other embodiments the polymer may be deposited via some other technique.

Next, the process may include applying a stamp to the polymer to form a molded polymer structure at 1010. Specifically, the stamp may be a “master” as described above that defines the desired optical coupler. The molded polymer structure may then be cured at 1015. Specifically, the molded polymer structure may be cured via application of UV light. In other embodiments, the molded polymer structure may be cured in a different manner. The stamp may then be removed at 1020, leaving behind the cured molded polymer structure which may be an optical coupler such as optical coupler 125, 225, or 325, or some other optical coupler.

Generally, embodiments herein may provide a variety of advantages. Specifically, embodiments herein may enable on-chip conversion of optical modes from silicon waveguides to a size compatible with SMFs. In doing so, the optical loss realized by embodiments herein may be substantially lower than legacy photonic chips that used silicon nitride couplers. This reduced optical loss may reduce one or more of power, sensitivity, or loss requirements of the photonic chip itself or components coupled with the photonic chip. Additionally, the cost of manufacturing the optical couplers or a photonic chip that includes the optical couplers may be significantly reduced by batch-fabricating the couplers on-wafer, thereby eliminating tedious and costly lens alignment/assembly. Additionally, because the optical coupler is deposited directly onto the photonic chip, the packaging process may be significantly simplified, thereby leading to reduced cost and manufacturing time.

### EXAMPLES

Example 1 may include a photonic chip comprising: a silicon waveguide to transmit light in a first direction; and a polymer optical coupler that includes a first portion at least partially coupled to a face of the silicon waveguide and a second portion adjacent to the first portion; wherein a first side of the second portion of the polymer optical coupler adjacent to the first portion has a width measured perpendicular to the first direction and the face of the silicon waveguide that is less than a width of a second side of the second portion opposite the first side.

Example 2 may include the photonic chip of example 1, wherein the silicon waveguide has a width of less than or equal to approximately 1 micron and a height measured perpendicular to the face of the silicon waveguide of less than or equal to approximately 1 micron.

Example 3 may include the photonic chip of example 2, wherein the first portion of the polymer optical coupler has a width of approximately 4 microns and a height of approximately 4 microns.

Example 4 may include the photonic chip of example 2, wherein the first side of the second portion has a width of approximately 4 microns and a height of approximately 4 microns.

Example 5 may include the photonic chip of example 2, wherein the second side of the second portion has a width of between approximately 8 and approximately 20 microns and a height of between approximately 8 and approximately 20 microns.

Example 6 may include the photonic chip of examples 1 or 2, wherein the first portion of the polymer optical coupler has a length measured parallel to the first direction of between approximately 200 and approximately 400 microns.

Example 7 may include the photonic chip of examples 1 or 2, wherein the silicon waveguide is disposed on a face of a dielectric stack, and the second portion is coupled to the face of the dielectric stack.

Example 8 may include the photonic chip of examples 7, wherein the polymer optical coupler includes a third portion that at least overlaps the second portion such that the second portion is positioned between the dielectric stack and the third portion.

Example 9 may include the photonic chip of example 8, wherein the third portion has a constant height as measured in a direction perpendicular to the face of the dielectric stack, a first end that is adjacent to the first end of the second portion, and a second end that is adjacent to the second end of the second portion, wherein a width of the second end of the third portion as measured in a direction perpendicular to the height of the third portion and the first direction is between 8 and 20 microns, and wherein a width of the first end of the third portion is less than the width of the second end of the third portion.

Example 10 may include a system comprising: a SMF; and a photonic chip coupled with the SMF, the photonic chip comprising: a silicon waveguide to transmit light in a first direction; and a polymer optical coupler that includes a first portion at least partially coupled to a face of the silicon waveguide and a second portion adjacent to the first portion; wherein a first side of the second portion of the polymer optical coupler adjacent to the first portion has a width measured perpendicular to the first direction and the face of the silicon waveguide that is less than a width of a second side of the second portion opposite the first side.

Example 11 may include the photonic chip of example 10, wherein the silicon waveguide has a width of less than or equal to approximately 1 micron and a height measured perpendicular to the face of the silicon waveguide of less than or equal to approximately 1 micron.

Example 12 may include the photonic chip of example 11, wherein the first portion of the polymer optical coupler has a width of approximately 4 microns and a height of approximately 4 microns.

Example 13 may include the photonic chip of example 11, wherein the first side of the second portion has a width of approximately 4 microns and a height of approximately 4 microns.

Example 14 may include the photonic chip of example 11, wherein the second side of the second portion has a width of between approximately 8 and approximately 20 microns and a height of between approximately 8 and approximately 20 microns.

Example 15 may include the photonic chip of examples 10 or 11, wherein the first portion of the polymer optical coupler has a length measured parallel to the first direction of between approximately 200 and approximately 400 microns.

Example 16 may include the photonic chip of examples 10 or 11, wherein the silicon waveguide is disposed on a face of a dielectric stack and wherein the second portion is coupled to the face of the dielectric stack.

Example 17 may include the photonic chip of example 16, wherein the polymer optical coupler includes a third portion that at least overlaps the second portion such that the second portion is positioned between the dielectric stack and the third portion.

Example 18 may include the photonic chip of example 17, wherein the third portion has a constant height as measured in a direction perpendicular to the face of the dielectric stack, a first end that is adjacent to the first end of the second portion, and a second end that is adjacent to the second end of the second portion, wherein a width of the second end of the third portion as measured in a direction perpendicular to the height and the first direction is between 8 and 20 microns, and wherein a width of the first end of the third portion is less than the width of the second end of the third portion.

Example 19 may include the photonic chip of examples 10 or 11, wherein the polymer optical coupler is composed of an ultraviolet (UV)-curable acrylate material.

Example 20 may include a process of forming a polymer optical coupler on a photonic chip, the process comprising: depositing polymer at least partially directly on a silicon waveguide of the photonic chip; applying a stamp to the polymer to form a molded polymer structure; curing the molded polymer structure to form a polymer optical coupler at least partially directly on the silicon waveguide of the photonic chip; and removing the stamp.

Example 21 may include the process of example 20, wherein the polymer is deposited via inkjet.

Example 22 may include the process of example 20, wherein curing includes curing with ultraviolet (UV) light.

Example 23 may include the process of any of examples 20-22, wherein the silicon waveguide is to transmit light in a first direction along the photonic chip.

Example 24 may include the process of example 23, wherein the polymer optical coupler includes a first portion at least partially coupled to a face of the silicon waveguide and a second portion coupled to a face of a dielectric stack on which the silicon waveguide is disposed, wherein the second portion is adjacent to the first portion; wherein a first side of the second portion of the polymer optical coupler adjacent to the first portion has a width measured perpendicular to the first direction and the face of the dielectric stack that is less than a width of a second side of the second portion opposite the first side.

Example 25 may include the process of example 24, wherein the silicon waveguide has a width of less than or equal to approximately 1 micron and a height measured perpendicular to the face of the dielectric stack of less than or equal to approximately 1 micron.

Example 26 may include the process of example 25, wherein the first portion of the polymer optical coupler has a width of approximately 4 microns and a height of approximately 4 microns.

Example 27 may include the process of example 25, wherein the first side of the second portion has a width of approximately 4 microns and a height of approximately 4 microns.

Example 28 may include the process of example 25, wherein the second side of the second portion has a width of between approximately 8 and approximately 20 microns and a height of between approximately 8 and approximately 20 microns.

Example 29 may include the process of example 24, wherein the first portion of the polymer optical coupler has a length measured parallel to the first direction of between approximately 200 and approximately 400 microns.

Example 30 may include the process of example 24, wherein the polymer optical coupler includes a third portion that at least overlaps the second portion such that the second portion is positioned between the dielectric stack and the third portion.

Example 31 may include a photonic chip comprising: a silicon waveguide disposed on a face of a dielectric stack, wherein the silicon waveguide is to transmit light in a first direction; and a polymer optical coupler deposited directly on a face of the silicon waveguide; and a mirror disposed at least partially within the silicon waveguide, wherein the mirror is to deflect light from the first direction to a second direction through the polymer optical coupler.

Example 32 may include the photonic chip of example 31, wherein the polymer optical coupler has a height measured in a direction perpendicular to the face of the dielectric stack of between 100 microns and 1 millimeter (mm).

Example 33 may include the photonic chip of example 31, wherein the polymer optical coupler has a width measured in a direction perpendicular to the first direction and the face of the dielectric stack of between 100 microns and 1 millimeter (mm).

Example 34 may include the photonic chip of example 31, wherein the polymer optical coupler has a length measured in a direction parallel to the first direction of between 100 microns and 1 millimeter (mm).

Example 35 may include the photonic chip of any of examples 31-34, wherein the polymer optical coupler has a generally circular cross section.

Example 36 may include the photonic chip of any of examples 31-34, wherein the polymer optical coupler is composed of a ultraviolet (UV)-curable acrylate material.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

What is claimed is:

1. A photonic chip comprising:
a silicon waveguide to transmit light in a first direction; and
a polymer optical coupler that includes a first portion at least partially coupled to a face of the silicon waveguide and a second portion adjacent to the first portion;
wherein a first side of the second portion of the polymer optical coupler adjacent to the first portion has a width measured perpendicular to the first direction and the face of the silicon waveguide that is less than a width of a second side of the second portion opposite the first side.

2. The photonic chip of claim 1, wherein the silicon waveguide has a width of less than or equal to approximately 1 micron and a height measured perpendicular to the face of the silicon waveguide of less than or equal to approximately 1 micron.

3. The photonic chip of claim 2, wherein the first portion of the polymer optical coupler has a width of approximately 4 microns and a height of approximately 4 microns.

4. The photonic chip of claim 2, wherein the first side of the second portion has a width of approximately 4 microns and a height of approximately 4 microns.

5. The photonic chip of claim 2, wherein the second side of the second portion has a width of between approximately 8 and approximately 20 microns and a height of between approximately 8 and approximately 20 microns.

6. The photonic chip of claim 1, wherein the first portion of the polymer optical coupler has a length measured parallel to the first direction of between approximately 200 and approximately 400 microns.

7. The photonic chip of claim 1, wherein the silicon waveguide is disposed on a face of a dielectric stack, and the second portion is coupled to the face of the dielectric stack.

8. The photonic chip of claim 7, wherein the polymer optical coupler includes a third portion that at least overlaps the second portion such that the second portion is positioned between the dielectric stack and the third portion;
wherein the third portion has a constant height as measured in a direction perpendicular to the face of the dielectric stack, a first end that is adjacent to the first end of the second portion, and a second end that is adjacent to the second end of the second portion, wherein a width of the second end of the third portion as measured in a direction perpendicular to the height of the third portion and the first direction is between 8 and 20 microns, and wherein a width of the first end of the third portion is less than the width of the second end of the third portion.

9. A system comprising:
a single mode fiber (SMF); and
a photonic chip coupled with the SMF, the photonic chip comprising:
a silicon waveguide to transmit light in a first direction; and
a polymer optical coupler that includes a first portion at least partially coupled to a face of the silicon waveguide and a second portion adjacent to the first portion;
wherein a first side of the second portion of the polymer optical coupler adjacent to the first portion has a width measured perpendicular to the first direction and the face of the silicon waveguide that is less than a width of a second side of the second portion opposite the first side.

10. The photonic chip of claim 9, wherein the silicon waveguide has a width of less than or equal to approximately 1 micron and a height measured perpendicular to the face of the silicon waveguide of less than or equal to approximately 1 micron.

11. The photonic chip of claim 9, wherein the first portion of the polymer optical coupler has a length measured parallel to the first direction of between approximately 200 and approximately 400 microns.

12. The photonic chip of claim 9, wherein the silicon waveguide is disposed on a face of a dielectric stack;
wherein the second portion is coupled to the face of the dielectric stack; and
wherein the polymer optical coupler includes a third portion that at least overlaps the second portion such that the second portion is positioned between the dielectric stack and the third portion.

13. The photonic chip of claim 9 wherein the polymer optical coupler is composed of a ultraviolet (UV)-curable acrylate material.

14. A process of forming a polymer optical coupler on a photonic chip, the process comprising:
depositing polymer at least partially directly on a silicon waveguide of the photonic chip;
applying a stamp to the polymer to form a molded polymer structure;
curing the molded polymer structure to form a polymer optical coupler at least partially directly on the silicon waveguide of the photonic chip; and
removing the stamp.

15. The process of claim 14, wherein the polymer is deposited via inkjet.

16. The process of claim 14, wherein curing includes curing with ultraviolet (UV) light.

17. The process of claim 14, wherein the silicon waveguide is to transmit light in a first direction along the photonic chip.

18. The process of claim 17, wherein the polymer optical coupler includes a first portion at least partially coupled to a face of the silicon waveguide and a second portion coupled to a face of a dielectric stack on which the silicon waveguide is disposed, wherein the second portion is adjacent to the first portion; and
wherein a first side of the second portion of the polymer optical coupler adjacent to the first portion has a width measured perpendicular to the first direction and the face of the dielectric stack that is less than a width of a second side of the second portion opposite the first side.

19. The process of claim 18, wherein the silicon waveguide has a width of less than or equal to approximately 1 micron and a height measured perpendicular to the face of the dielectric stack of less than or equal to approximately 1 micron.

20. The process of claim 18, wherein the polymer optical coupler includes a third portion that at least overlaps the second portion such that the second portion is positioned between the dielectric stack and the third portion.

21. A photonic chip comprising:
a silicon waveguide disposed on a face of a dielectric stack, wherein the silicon waveguide is to transmit light in a first direction;
a polymer optical coupler deposited directly on a face of the silicon waveguide; and
a mirror disposed at least partially within the silicon waveguide, wherein the mirror is to deflect light from the first direction to a second direction through the polymer optical coupler.

22. The photonic chip of claim 21, wherein the polymer optical coupler has a height measured in a direction perpendicular to the face of the dielectric stack of between 100 microns and 1 millimeter (mm).

23. The photonic chip of claim 21, wherein the polymer optical coupler has a width measured in a direction perpendicular to the first direction and the face of the dielectric stack of between 100 microns and 1 millimeter (mm).

24. The photonic chip of claim 21, wherein the polymer optical coupler has a length measured in a direction parallel to the first direction of between 100 microns and 1 millimeter (mm).

25. The photonic chip of claim 21, wherein the polymer optical coupler is composed of a ultraviolet (UV)-curable acrylate material.
